(19) United States
(12) Patent Application Publication
(10) Pub. No.: US 2007/0138860 A1
(43) Pub. Date: Jun. 21, 2007

(54) Wheel spoke and a method for the manufacture thereof

(76) Inventors: Guido Cappellotto, Lomagna (IT); Moreno Fioravanti, Lomagna (IT); Joao Miranda Carlos Ribeiro, Lomagna (IT); Steve Kawai, Lomagna (IT)

Correspondence Address: RATNERPRESTIA, P O BOX 980, VALLEY FORGE, PA, 19482-0980, US

(21) Appl. No.: 10/538,696

(22) PCT Filed: Dec. 12, 2003
(86) PCT No.: PCT/IT03/00812

§ 371 Date: Oct. 27, 2006

(30) Foreign Application Priority Data
Dec. 13, 2002 (IT) BO2002A000783
Dec. 24, 2002 (IT) PD2002A000334
Feb. 3, 2003 (EP) 03002313.9
Mar. 28, 2003 (EP) 03007123.7

(51) Int. Cl. B60B 1/00

(52) U.S. Cl. 301/104

(57) ABSTRACT

The invention relates to a spoke for wheels and its method of manufacture. The spoke includes a shaft on a longitudinal end of which a terminal element carrying a device for the attachment of the spoke to the respective component of the wheel is fitted by a fixing device. The fixing device includes a stud-bolt-type connection. A method for the manufacture of the spoke includes the steps of preparing the shaft and separately preparing the terminal element to be arranged as an extension of the shaft by the stud-bolt-type connection.

### BACKGROUND OF THE INVENTION

The invention relates to a spoke for wheels and also relates to a method for the production thereof.

Specifically, the preferred application of the invention is for the production of spokes from light alloy. On account of their mechanical strength characteristics, these materials are unsuitable for the production of spokes by conventional methods.

Typically, wheel spokes, including those made of light alloy, comprise a shaft having an end (for example, shaped with an enlarged head) for attachment to the wheel hub and, at the axially opposite end, a thread onto which a nipple, by means of which the spoke is connected to the wheel rim, is screwed adjustably. A spoke with these characteristics can easily be produced from strong materials such as steel but presents some problems of mechanical strength when made of aluminium alloy. The greatest problem arises in the region of the nipple screw-thread which is liable to give way and be damaged under stress. The spoke consequently becomes loose or breaks.

JP60080901A2 in the name of MITSUBISHI RAYON CO. LTD. describes a composite wheel spoke including a reinforced-resin shaft with a fibre reinforcement, on the ends of which respective metal terminals are fitted. However, this solution is not suitable for the production of light alloy spokes since it involves a considerable dimensional increase of the ends of the spoke in the region of the terminals, relative to the shaft. In light alloy spokes, the shaft itself is already thick.

Substantially similar problems are encountered with reference to the spoke described in U.S. Pat. No. 6,036,279 in the name of Campagnolo Srl.

### BRIEF DESCRIPTION OF THE INVENTION

The main task of the invention is to provide a strong and reliable spoke, preferably of the type having a light alloy shaft.

Within the scope of this task, an important object of the invention is to define a method for the production of such a spoke in a reliable and secure manner with reasonably low costs.

Another object of the invention is to limit the dimensions of the spoke, in particular in the region of the nipple screw-thread and/or in the region of the head.

A further object of the invention is to permit the use of conventional rims and nipples while using light alloy spokes.

According to an aspect of this invention a spoke for wheels is provided. The spoke includes a shaft having opposed longitudinal ends. On at least one of the ends a terminal element is provided for carrying a device for the attachment of the spoke to a respective wheel component. The device is fitted by fixing means, the fixing means comprise a stud-bolt-type threaded connection between the shaft and the terminal element.

According to another aspect of this invention a method for the manufacture of a wheel spoke is provided. The method comprises the steps of preparing a shaft and separately preparing at least one terminal element to be arranged as an extension of the shaft. The shaft is made of a material having a mechanical strength less than that of the material with which the terminal element is made. The terminal element is fitted on the shaft by a stud-bolt-type connection, thereby firmly fixing the shaft and the terminal together axially.

According to yet another aspect of this invention a wheel spoke is produced by press-forging of metal alloy and has a substantially Y-shaped configuration with two shanks at the same end. The shanks have respective threaded portions for the engagement of respective nipples.

### BRIEF DESCRIPTION OF THE DRAWINGS

The characteristics and the advantages of the invention will become clearer from the detailed description of a preferred embodiment thereof which is described by way of non-limiting example with reference to the appended drawings, in which:

FIG. 1 is a partially-sectioned, elevational view of a detail of a bicycle wheel equipped with a spoke according to the present invention.

FIG. 2 is an elevational view of a detail of the spoke of FIG. 1, on an enlarged scale.

FIG. 3 is a partially-sectioned, elevational view of a detail of a bicycle wheel equipped with a spoke according to a variant of the present invention.

FIGS. 4 and 5 are elevational views, on an enlarged scale, of the details indicated by the arrows IV and V of FIG. 3, respectively.

FIGS. 6 and 7 are partially-sectioned front and side views of a wheel spoke according to a further variant of the invention.

FIG. 8 is a section through a detail of the spoke of FIGS. 6 and 7, on an enlarged scale.

FIG. 9 is an elevational view of a further spoke according to the invention.

FIG. 10 incorporates a series of cross-sectional views of various profiles of the spoke of FIG. 9.

FIGS. 11 to 17 are elevational views of spokes of different shapes produced in accordance with the invention.

FIGS. 18-19, 20-21 and 22-23 are front and side elevational views, respectively, of a corresponding number of spokes produced in accordance with the invention.

FIG. 24 is a side elevational view of a further spoke according to the invention.

### DETAILED DESCRIPTION OF THE INVENTION

In the drawings, a spoked wheel, generally indicated R, includes a rim C connected to a wheel hub (not shown), by means of a plurality of spokes 10. Each spoke is connected to the wheel hub at one end by means of an attachment having a head 11 (the shape and arrangement of the head 11 may be varied as desired) and to the rim C at the other end by means of a respective nipple N.

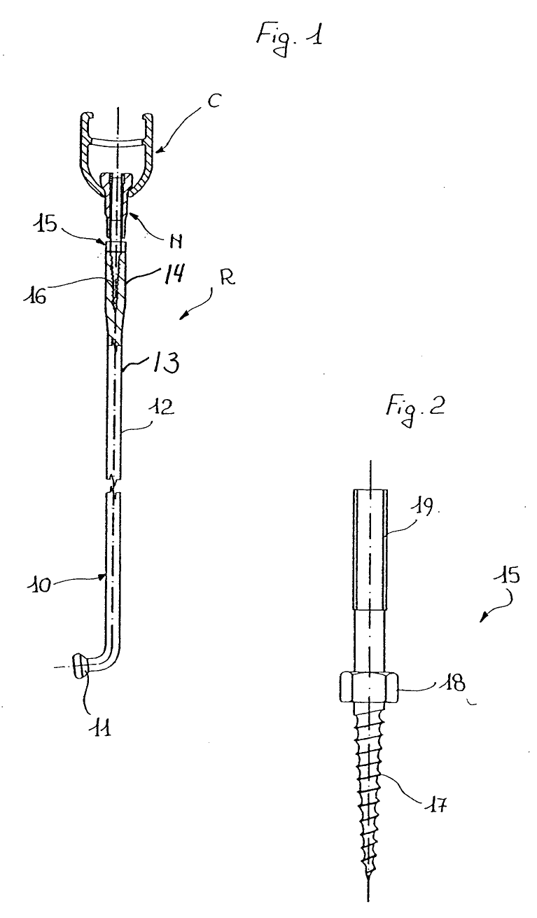

Each spoke 10 comprises a straight shaft 12 which, in the embodiment of FIGS. 1 and 2, is formed, integrally with the head 11, from light alloy, for example, aluminium alloy. Amongst the alloys most suitable for this purpose, the following are mentioned: Anticorodal 100, Avional 22, Avional 14, Avional 24, Ergal 55.

A terminal element 15 carrying a screw thread 19 for the nipple N is fitted on the longitudinal end 13 of the shaft 12 remote from the head 11, by fixing means 14.

According to the invention, the fixing means 14 comprise a stud-bolt-type connection with a blind axial hole 16 in the end of the shaft 12 and a self-tapping thread 17 on the terminal element 15.

The terminal element is made of steel and therefore has greater mechanical strength than the material of which the shaft is made. Both the hole 16 and the thread 17 are formed with conical profiles.

A driving key 18, for example, with a hexagonal profile, is provided in an intermediate portion of the terminal element, for the driving of the terminal element 15 into the shaft 12. The terminal element 15 is preferably driven into the shaft 12 with interference, bringing about a localized expansion deformation thereof which is barely visible in FIG. 1.

In order to manufacture the spoke 10, the shaft 12 and the terminal element 15 which is to be arranged as an extension thereof are prepared separately. An axial hole 16 is then drilled in the shaft and the terminal element 15 is fitted on the shaft with a stud-bolt-type connection, firmly fixing the shaft and the terminal element together axially with interference.

The spoke thus formed is tear-resistant in the nipple-screwing region and is light and robust.

It also has limited dimensions particularly with regard to the nipple-screwing region so as to permit the use of standard nipples.

The invention is also suitable for the production of spokes of the type with a head anchored to the rim and a nipple anchored to the wheel hub.

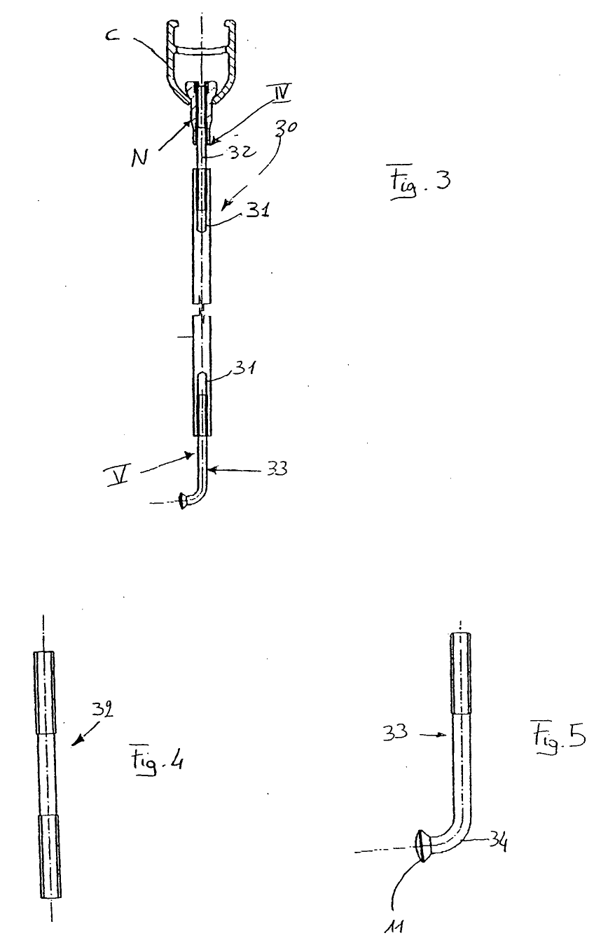

Finally, the spoke may be equipped with terminal elements of the type described at both of its longitudinal ends for fixing by means of nipples or similar devices both to the rim and to the hub. FIGS. 3 to 5 show an example of such a spoke, generally indicated 30. The spoke 30 has a light-alloy shaft drilled with blind holes 31 at both of its opposite ends. Respective terminal elements 32, 33 made of steel or other material with good mechanical strength are inserted in the two holes 31 with a stud-bolt-type connection. The first terminal element 32 is similar to the element 15 and is provided with a threaded portion for the screwing of the nipple N. The second terminal element is shaped as a standard attachment with a head 11 and an elbow 34. However, the second element may also be formed so as to be straight, or with a threaded portion, or in another manner. By virtue of these arrangements, light-alloy spokes can also be used on wheels the overall structure (rim and/or hub) of which is designed for the fitting of steel spokes, resulting in greater compactness and smaller dimensions both of the rim and of the hub, to the benefit of lightness and aerodynamic characteristics, etc.

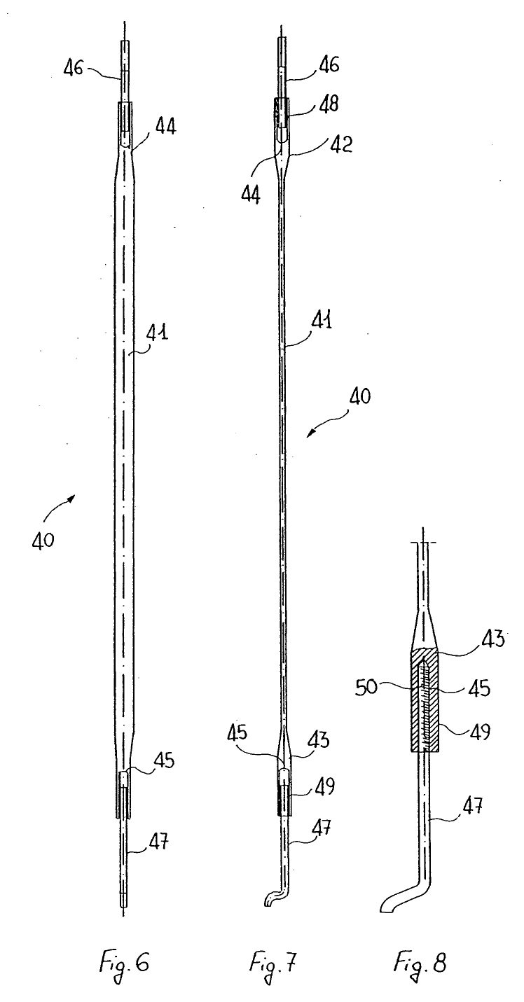

A third variant of the spoke of the invention is indicated 40 in FIGS. 6 to 8. The shaft 41 of the spoke 40 is flattened in its intermediate portion by calendering or an equivalent technique and has circular-sectioned cylindrical end portions 42, 43 in which the respective blind axial holes 44, 45 are formed.

Each of the terminal elements 46, 47 carries a threaded portion 48, 49 to be screwed into the respective hole 44, 45, preferably with a force fit. The terminal element 46 carries a second, opposed threaded portion for the screwing of the nipple, and the element 47 carries a so-called Z-shaped head for engaging a corresponding hole in the hub.

The length or depth of the axial holes 44, 45 is such that, when the corresponding threaded portion 48, 49 has been fully screwed in, a free chamber 50 no less than approximately one third of the overall length of the hole remains in the hole. It has been found that this chamber 50 is useful for distributing, within adequate and tolerable values, the excess pressures resulting both from the deformation of the shaft of the spoke due to the forcing of the corresponding terminal element and from the increase in pressure of the fluids that are trapped in the chamber 50 during the screwing of the threaded portion 48, 49. In fact, since the screwing of the threaded portion takes place without previous threading of the blind hole, (in practice the thread of the steel portion 48, 49 deforms the aluminium alloy walls of the blind hole forming a substantially fluid-tight self-tapping connection) the air, with any liquids and vapours trapped in the blind hole 44, 45, is compressed as a result of the progressive reduction in the volume of the chamber and this leads to an increase in the stresses on the shaft of the spoke in the end region which is already weakened by the presence of the blind hole 44, 45.

The invention thus solves the problem posed and affords many advantages over the prior art. In the first place, it permits the use of conventional rims and hubs without requiring any specific adaptation. Moreover, the spoke is strong and reliable. Not the least advantage is that it is light and suitable to be manufactured with advantageous aerodynamic profiles and/or profiles with distinctive aesthetic effects which, amongst other things, can confer on the assembled wheel a visual effect similar to that of a wheel with integral spokes.

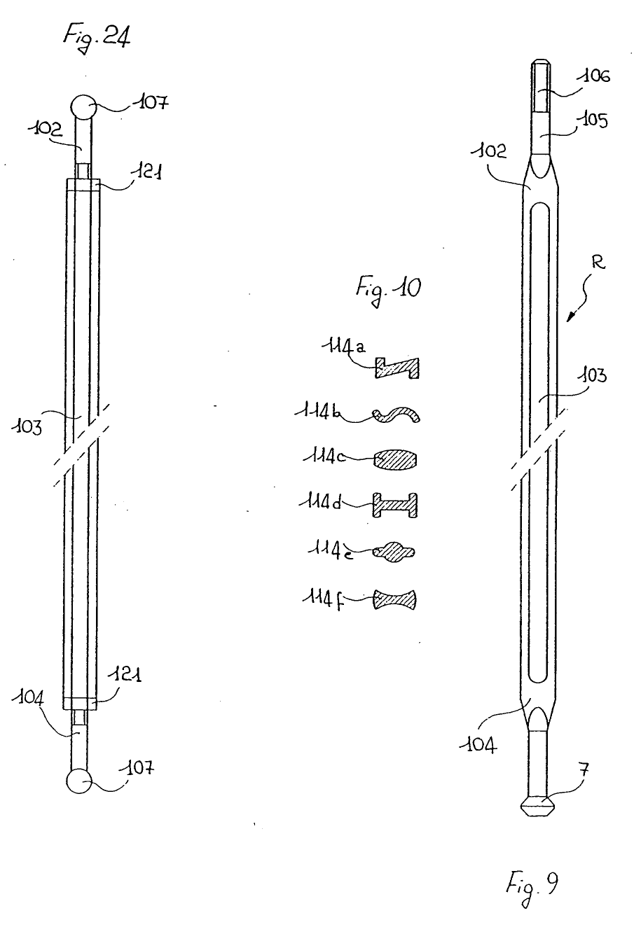

Some of these profiles are described in Italian patent application No. BO 2002A783, the text of which is considered to be included in the present description, forming an integral part thereof. These profiles are represented, by way of example, by the spoke cross-sections 114a-f which are described with reference to FIGS. 9 and 10. They are produced by a processing method which comprises the preparation of semi-finished elements in the form of billets of light alloy such as the alloys identified above (trade names Ergal, Avional, Peraluman, Anticorodal), which are cut into pieces of suitable length and subjected to press-forging in a press suitably equipped with dies and matrices suitable for the forging of metal alloy spokes.

FIGS. 11 to 17 relate to alternative embodiments of the spoke that can be produced by the method. From the front, they are substantially lance-shaped, having a longitudinal aperture 118 which extends from a first end 102 to a second end 104 and a central portion 103 therebetween. Substantially triangular lateral ribs 119, arranged reflectively symmetrically with respect to the longitudinal plane of symmetry of the spoke, are provided in the region of the first and second ends. The second end 104 is bent into an elbow (FIG. 12) to facilitate the engagement of the head 107 in the respective hole provided in the wheel hub. The first end 102 includes a shank 105 having respective threaded portion 106 which engages a nipple (not shown).

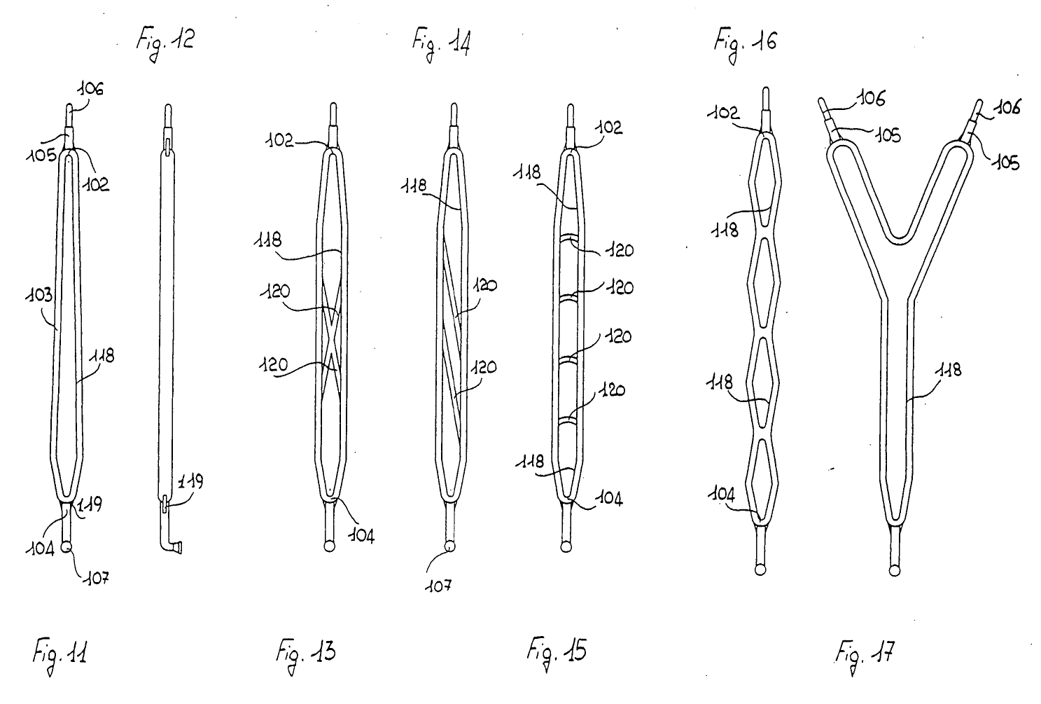

FIG. 13 is a front view of a lanceolate spoke having a longitudinal slot-like aperture 118 interrupted by a pair of bridges 120 in a substantially X-shaped arrangement. FIG. 14 relates to an embodiment in which the two bridges 120 are arranged parallel to one another, substantially diagonally, and FIG. 15 shows a further embodiment provided with four substantially transverse bridges 120. A further embodiment is shown in FIG. 16; it provides for the formation of four substantially lozenge-shaped, aligned longitudinal apertures 118. FIG. 17 shows another embodiment of the spoke which can be produced by the method according to the invention, in which the first end 102 for fixing to the rim is substantially Y-shaped with two shanks 105 having respective threaded portions 106 which engage in respective nipples. The spoke has a substantially Y-shaped central aperture 118 corresponding to the shape of the spoke itself. The central portions 103 of the embodiments of the spokes shown in FIGS. 11-17 have composite cross-sections which, moreover, are variable from one end of the same spoke to the other.

In FIGS. 18 to 23, the spoke has a simple or composite cross-section of the central portion 103 (in the embodiment in question, the central portion is substantially flattened), both the first end 102 and the second end 104 having respective cylindrical shanks 105 having threaded end portions 106 for engagement in respective nipples.

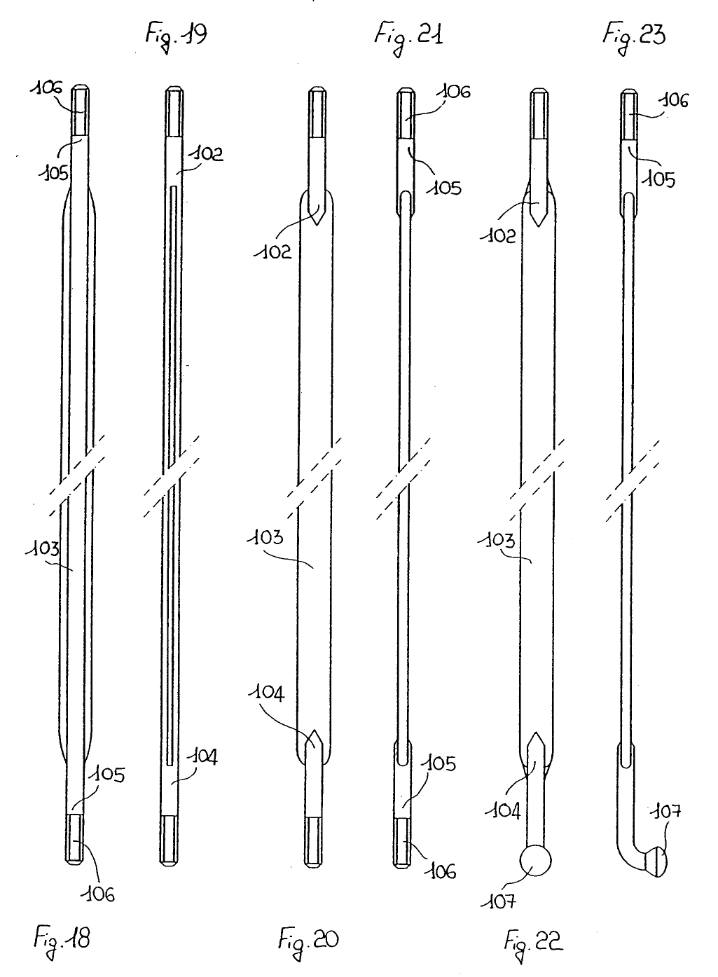

FIGS. 22 and 23 show a front view and a side elevation, respectively, of the spoke of FIGS. 20, 21, but in which the second end 104 forms a head 107 for engagement in the wheel hub.

FIG. 24 shows an embodiment of the spoke which can be produced by the method according to the invention and in which the first and second ends 102, 104 are removable, that is, interchangeable. In the spoke of FIG. 24, each of the ends 102, 104 is substantially in the form of a partially threaded shaft which is engaged releasably, with the aid of a lock nut 121, in a respective female thread formed in the central portion 103 of the spoke. The ends 102, 104 form respective spherical heads 107 for anchoring to the hub and to the rim of the wheel.

The spokes that can be produced by the method according to the invention are distinguished by a high degree of strength, toughness and resilience, combined with considerable lightness. They also permit the production of wheels with aesthetic and functional characteristics which are innovative with respect to conventional types; moreover, a further considerable production advantage can be recognized and consists in that there is no need to provide a complete wheel die, as for the production of monolithic diecast wheels, but the geometry of the wheel can be varied appreciably simply by replacing the spoke-forging dies and matrices.

1. A spoke for wheels including a shaft having opposed longitudinal ends, on at least one of the ends a terminal element is provided for carrying a device for the attachment of the spoke to a respective wheel component, the device is fitted by fixing means, the fixing means comprise a stud-bolt-type threaded connection between the shaft and the terminal element.

2. The spoke according to claim 1 in which the stud-bolt-type connection comprises an axial hole in the end of the shaft and a thread on the terminal element, the coupling between the hole and the thread being of the threaded or self-tapping type.

3. The spoke according to claim 1 in which the shaft is made of a material having a mechanical strength less than that of the material of which the terminal element is made.

4. The spoke according to claim 2 in which the shaft is made of light alloy.

5. The spoke according to claim 2 in which the terminal element is made of steel.

6. The spoke according to claim 2 in which the self-tapping thread is formed with a conical profile.

7. The spoke according to claim 1 in which a driving key is provided in an intermediate portion of the terminal element, for the driving of the terminal element into the shaft.

8. The spoke according to claim 1 in which the terminal element is driven into the shaft with interference.

9. The spoke according to claim 1 in which the terminal element is provided, at the end remote from the shaft, with means for connection to a nipple.

10. The spoke according to claim 1 in which the terminal element is provided, at the end remote from the shaft, with means for connection to a wheel hub.

11. The spoke according to claim 9 in which the connection means comprise a threaded portion of the terminal element.

12. The spoke according to claim 10 in which the means for connection to a hub comprise an attachment element.

13. The spoke according to claim 2 in which the hole in the shaft is blind and has a greater length than the threaded portion of the terminal element which is engaged therein, so as to define a chamber in the hole.

14. The spoke according to claim 13 in which the axial length of the chamber is greater than or equal to one third of the overall axial length of the blind hole.

15. A method for the manufacture of a wheel spoke comprising the steps of preparing a shaft and separately preparing at least one terminal element to be arranged as an extension of the shaft, the shaft being made of a material having a mechanical strength less than that of the material with which the terminal element is made, and fitting the terminal element on the shaft by a stud-bolt-type connection, thereby firmly fixing the shaft and the terminal together axially.

16. The method according to claim 15 in which the connection is forced with interference.

17. The method according to claim 15 in which the stud-bolt-type connection is performed with a self-tapping coupling.

18. A wheel spoke produced by press-forging of metal alloy and having a substantially Y-shaped configuration with two shanks at the same end, the shanks having respective threaded portions for the engagement of respective nipples.

19. The spoke according to claim 18 including a central aperture of a shape corresponding to the external shape of the spoke itself.
